(19) United States
(12) Patent Application Publication
(10) Pub. No.: US 2025/0334306 A1
(43) Pub. Date: Oct. 30, 2025

(54) WATER SOURCED HEAT PUMP (WSHP) SYSTEM OPTIMIZATION USING REINFORCEMENT LEARNING (RL) AGENT

(71) Applicant: HONEYWELL INTERNATIONAL INC., Charlotte, NC (US)

(72) Inventors: Karel Marik, Revnice (CZ); Ihor Varha, Praha (CZ); Raman Samusevich, Praha (CZ)

(21) Appl. No.: 18/645,486

(22) Filed: Apr. 25, 2024

(51) Int. Cl. F25B 49/00; F25B 30/00

(52) U.S. Cl. CPC F25B 49/00; F25B 30/00; F25B 2700/15

(57) ABSTRACT

A method for optimizing a water sourced heat pump (WSHP) system using reinforcement learning (RL) agent is disclosed. The method comprises deploying, via at least one processor, a trained RL agent in the WSHP system comprising a plurality of WSHPs; analyzing state variables associated with the WSHP system in real-time, using the trained RL agent, generating, via the at least one processor, one or more action variables using the trained RL agent based at least on the analyzed state variables associated with the WSHP system, wherein the one or more action variables comprises at least one of water loop temperature and water loop flow rate; generating at least one reward function based on the generated one or more action variables, and optimizing at least one of the water loop temperature and the water loop flow rate of the WSHP system based on the generated at least one reward function.

### TECHNOLOGICAL FIELD

The present invention relates to water sourced heat pump (WSHP) system, and more particularly relates to the WSHP system optimization using reinforcement learning (RL) agent.

### BACKGROUND

Water sourced heat pump (WSHP) system is used for regulating internal temperatures of an area such as buildings. The WSHP system comprises multiple water sourced heat pumps (WSHPs). The WSHP system having multiple WSHPs that operate by rejecting heat to a water-pipe system (or water loop) and providing heating or cooling to zones or air handlers. The WSHP system uses water as the heat exchange medium instead of air. The WSHP operates on the same principles as an air source heat pump but utilizes water from a nearby source such as a well, lake, river, or pond, for the heat exchange process. The WSHP extracts heat from the water source during the heating season and transfers it into the building to provide warmth. During the cooling season, the WSHP removes heat from the building and releases it into the water source. The WSHP uses closed-loop systems to circulate water between the heat pump and the water source. Such closed-loop systems allow the heat pump to continuously exchange heat with the water source. In a large building, there can be multiple (hundreds) WSHPs to form the WSHP system, which operate year-round by bringing in heat in the winter months and removing heat in the summer months. All the WSHPs in the WSHP system are connected to the common water loop. Further, the water loop is connected to a “heat rejecter” (e.g., cooling tower or geothermal heat exchanger), a “heat adder” (e.g., boiler or geothermal heat exchanger), circulation pumps, and related accessories.

The energy consumption of the WSHP system can vary based on several factors including the size and efficiency of the unit, the climate in which it operates, the temperature of the water source, and the heating or cooling demands of the building it serves. The WSHP system rely on the temperature differential between the water source and desired indoor temperature to exchange heat effectively. When the water temperature is too low (in the case of heating) or too high (in the case of cooling), the efficiency of heat exchange can be reduced. The WSHP system comprises a compressor that is responsible for circulating the refrigerant and facilitating the heat exchange process. When the water temperature is outside an optimal range, the compressor may need to work harder to achieve the desired heating or cooling effect, resulting in higher energy consumption and reduced efficiency. On the other hand, in situations where the water temperature is too low for heating or too high for cooling, the WSHP may require supplemental heating or cooling mechanisms to maintain indoor comfort levels. Such supplemental mechanisms can consume additional energy and reduce overall system efficiency. Further, the efficiency impact of water temperature inside the WSHP system may also vary seasonally. For example, in colder climates during the heating season, lower water temperatures may reduce efficiency more significantly as compared to warmer climates or during the cooling season. The opportunity to minimize purchased building-level utility costs, typically electricity, lies in optimizing the technology water loop temperature and flowrate.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method is disclosed. The method comprises deploying, via at least one processor, a trained reinforcement learning (RL) agent in a water sourced heat pump (WSHP) system comprising a plurality of WSHPs. The method further comprises analyzing, via the at least one processor, one or more state variables associated with the WSHP system in real-time, using the trained RL agent. The one or more state variables corresponds to a current state of each of the plurality of WSHPs, external heat sources of each of the plurality of WSHPs, or water loop temperature in the WSHP system. The method further comprises generating, via the at least one processor, one or more action variables using the trained RL agent based at least on the analyzed one or more state variables associated with the WSHP system. The one or more action variables comprises at least one of water loop temperature and water loop flow rate. The method further comprises generating, via the at least one processor, at least one reward function based on the generated one or more action variables. The at least one reward function corresponds to at least one of real time energy cost for operating the WSHP system, thermal discomfort within an operating area of the WSHP system, stability or degradation information of heat in water loop of the WSHP system. The method further comprises optimizing, via the at least one processor, at least one of the water loop temperature and the water loop flow rate of the WSHP system based on the generated at least one reward function.

In some embodiments, the trained RL agent is generated by the at least one processor by receiving the one or more state variables associated with the WSHP system, from one or more sensors, over a predefined period of time. Thereafter, the at least one processor trains the RL agent for the WSHP system based at least on the received one or more state variables.

In some embodiments, the optimization of the water loop temperature is performed by defining a water cooling temperature set point and a water heating temperature set point. In some embodiments, the water loop flow rate comprises at least one of a water flow rate, water pump speed, or water circuit delta pressure set point.

In some embodiments, the method further comprising determining, via the at least one processor, the real time energy cost for operating the WSHP system using a utility tariff module.

In some embodiments, the current state of the plurality of WSHPs comprises at least one of cooling intensity and heating intensity in a facility, occupancy level, and comfort state. In some embodiments, the external heat sources having one or more parameters such as electricity consumption of a cooling tower, fan speed, tower delta temperature, steam or hot water consumption, heat exchanger delta temperature, gas consumption, supply or return delta temperature, aggregated WSHP cooling intensity, aggregated WSHP heating intensity, aggregated WSHP electricity consumption, aggregated zone delta temperature, or aggregated occupancy level.

In some embodiments, the real time energy cost for operating the WSHP system corresponds to energy costs of the external heat sources and energy cost for the operating area of the WSHP system. In some embodiments, the at least one reward function comprises an energy component and zero or more penalties. Further, the zero or more penalties depends upon the thermal discomfort within the operating area of the WSHP system and the stability or degradation information of heat in the water loop of the WSHP system.

In another example embodiment, a system is disclosed. The system comprises a memory and at least one processor communicatively coupled to the memory. The at least one processor is configured to deploy a trained reinforcement learning (RL) agent in a water sourced heat pump (WSHP) system comprising a plurality of WSHPs. The at least one processor is further configured to analyze one or more state variables associated with the WSHP system in real-time, using the trained RL agent. The one or more state variables corresponds to a current state of the plurality of WSHPs, external heat sources of the plurality of WSHPs, or water loop temperature in the WSHP system. Further, the at least one processor is configured to generate one or more action variables using the trained RL agent based at least on the analyzed one or more state variables associated with the WSHP system. The one or more action variables comprises at least one of water loop temperature and water loop flow rate. Further, the at least one processor is configured to generate at least one reward function based on the generated one or more action variables. The at least one reward function corresponds to at least one of real time energy cost for operating the WSHP system, thermal discomfort within an operating area of each of the plurality of WSHPs, stability or degradation information of heat in water loop of the WSHP system. Thereafter, the at least one processor is configured to optimize at least one of the water loop temperature and the water loop flow rate of the WSHP system based on the generated at least one reward function.

In some embodiments, the at least one processor is further configured to receive the one or more state variables associated with the WSHP system, from one or more sensors, over a predefined period of time. Thereafter, the at least one processor is configured to train the RL agent for the WSHP system based at least on the received one or more state variables.

In some embodiments, the optimization of the water loop temperature is performed by defining a water cooling temperature set point and a water heating temperature set point. In some embodiments, the water loop flow rate comprises at least one of a water flow rate, water pump speed, or water circuit delta pressure set point.

In another example embodiment, a non-transitory machine-readable information storage medium is disclosed. The non-transitory machine-readable information storage medium comprising one or more instructions which when executed by at least one processor cause implementing a trained reinforcement learning (RL) agent for dynamically controlling at least one of water loop temperature and water loop flow rate of a water sourced heat pump (WSHP) system by deploying the trained RL agent in the WSHP system comprising a plurality of WSHPs; analyzing one or more state variables associated with the WSHP system in real-time, using the trained RL agent, wherein the one or more state variables corresponds to a current state of each of the plurality of WSHPs, external heat sources of each of the plurality of WSHPs, or water loop temperature in the WSHP system; generating one or more action variables using the trained RL agent based at least on the analyzed one or more state variables associated with the WSHP system, wherein the one or more action variables comprises at least one of water loop temperature and water loop flow rate; generating at least one reward function based on the generated one or more action variables, wherein the at least one reward function corresponds to at least one of real time energy cost for operating the WSHP system, thermal discomfort within an operating area of each of the WSHP system, stability or degradation information of heat in water loop of the WSHP system; and optimizing at least one of the water loop temperature and the water loop flow rate of the WSHP system based on the generated at least one reward function.

In some embodiments, the at least one processor is configured to receive the one or more state variables associated with the WSHP system, from one or more sensors, over a predefined period of time; and train the RL agent for the WSHP system based at least on the received one or more state variables.

In some embodiments, the optimization of the water loop temperature is performed by defining a water cooling temperature set point and a water heating temperature set point. In some embodiments, the water loop flow rate comprises at least one of a water flow rate, water pump speed, or water circuit delta pressure set point.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for optimizing a water sourced heat pump (WSHP) system using reinforcement learning (RL) agents in accordance with an example embodiment of the present disclosure;

FIG. 2 illustrates a block diagram of the server for optimizing the WSHP system using the RL agent in accordance with an example embodiment of the present disclosure;

FIG. 3 illustrates an exemplary scenario of the RL agent that is configured to be trained based on the received one or more state variables associated with the WSHP system in accordance with an example embodiment of the present disclosure;

FIG. 4 illustrates an exemplary scenario of the at least one processor that is configured to generate one or more action variables using the trained RL agent in accordance with an example embodiment of the present disclosure;

FIG. 5 illustrates an exemplary scenario of the at least one processor that is configured to generate at least one reward function using the trained RL agent in accordance with an example embodiment of the present disclosure;

FIG. 6 illustrates a flowchart showing a method for training the RL agent by the at least one processor, in accordance with an example embodiment of the present disclosure; and

FIG. 7 illustrates a flowchart showing a method for optimizing the WSHP system using the RL agent in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments for optimizing water sourced heat pumps (WSHP) using reinforcement learning (RL) agents. Embodiments may be configured to be executed by at least one processor for selecting state, action, and reward variables. Embodiments may be configured to receive by using at least one processor, one or more state variables associated with a water source heat pump (WSHP) system, from one or more sensors, over a predefined period of time. Embodiments may be configured to train by using the at least one processor, the RL agent for the WSHP system based at least on the received one or more state variables.

Embodiments may be configured to deploy a trained reinforcement learning (RL) agent in the WSHP system comprising a plurality of WSHPs. Embodiments may be configured to analyze one or more state variables associated with the WSHP system in real-time, using the trained RL agent. Embodiments may be configured to analyze the one or more state variables that corresponds to a current state of each of the plurality of WSHPs, external heat sources of each of the plurality of WSHPs, or water loop temperature in the WSHP system. The current state of the plurality of WSHPs comprises at least one of cooling intensity and heating intensity in a facility, occupancy level, and comfort state. Further, the external heat sources having one or more parameters such as electricity consumption of a cooling tower, fan speed, tower delta temperature, steam or hot water consumption, heat exchanger delta temperature, gas consumption, supply or return delta temperature, aggregated WSHP cooling intensity, aggregated WSHP heating intensity, aggregated WSHP electricity consumption, aggregated zone delta temperature, or aggregated occupancy level.

Embodiments may be configured to generate one or more action variables using the trained RL agent based at least on the analyzed one or more state variables associated with the WSHP system. Embodiment may be configured to generate the one or more action variables that comprises at least one of water loop temperature and water loop flow rate (water loop flow rate comprises at least one of a water flow rate, water pump speed, or water circuit delta pressure set point). Embodiments may be configured to generate at least one reward function based on the generated one or more action variables. Embodiment may be configured to generate the at least one reward function that corresponds to at least one of real time energy cost for operating the WSHP system, thermal discomfort within an operating area of the WSHP system, stability or degradation information of heat in water loop of the WSHP system. Embodiments may be configured to optimize at least one of the water loop temperature and the water loop flow rate of the WSHP system based on the generated at least one reward function by defining a water cooling temperature set point and a water heating temperature set point.

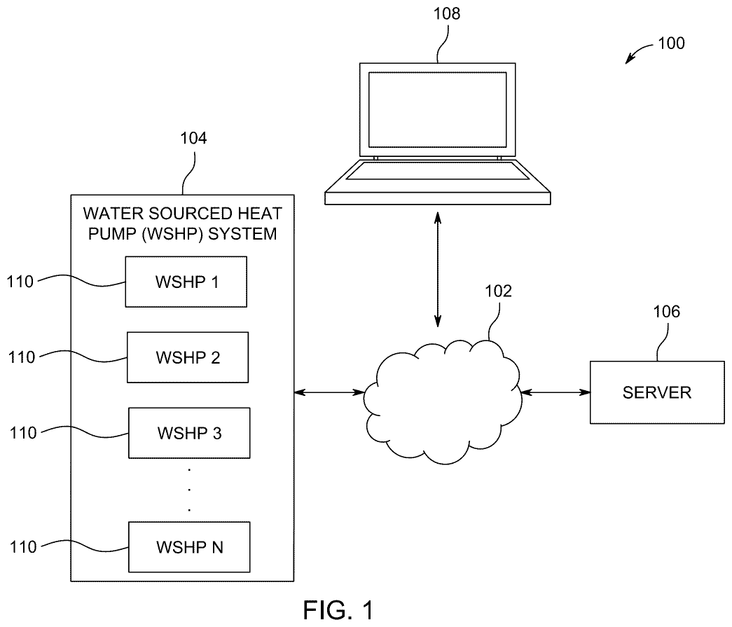

FIG. 1 illustrates a network diagram of a system 100 for optimizing water source heat pump (WSHP) system 104 using reinforcement learning (RL) agents, in accordance with an example embodiment of the present disclosure. The network diagram may comprise a network 102 communicatively coupled to the WSHP system 104, a server 106, and a user device 108.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

Further, the WSHP system 104 may be installed in a building for regulating and maintaining internal temperatures and may have a plurality of water source heat pumps (WSHPs) 110 (WSHP1, WSHP2, WSHP3 and WSHP N). Each WSHP of the plurality of WSHPs 110 may be a type of heat pump that operates by rejecting heat to a water-pipe system (or water loop) and providing heating or cooling to zones or air handlers. In some embodiments, the WSHP may be configured to extract heat from the water source during the heating season and transfers it into the building to provide warmth. Further, during the cooling season, the heat pump may be configured to remove heat from the building and release into the water source. The WSHP may comprise a closed-loop to circulate water between the heat pump and the water source. In some embodiments, the closed loop may allow the heat pump to continuously exchange heat with the water source. In some embodiments, the plurality of WSHPs 110 in the WSHP system 104 may be connected to the common water loop. Further, the water loop may be connected to a “heat rejecter” (e.g., cooling tower or geothermal heat exchanger), a “heat adder” (e.g., boiler or geothermal heat exchanger), circulation pumps, and related accessories.

In some embodiments, the server 106 may be a computer or software module that is configured to provide centralized resources, data, or services to the user device 108 operated by a user. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location. In some embodiments, the server 106 may be configured to deploy a trained RL agent (not shown) in the WSHP system 104 comprising the plurality of WSHPs 110. Further, the server 106 may be configured to analyze one or more state variables associated with the WSHP system 104 in real-time, using the trained RL agent. In one example embodiment, the one or more state variables corresponds to a current state of the plurality of WSHPs 110, external heat sources (not shown) of the plurality of WSHPs 110, or water loop temperature (not shown) in the WSHP system 104.

In some embodiments, the server 106 may be configured to generate one or more action variables using the trained RL agent based at least on the analyzed one or more state variables associated with the WSHP system 104. The one or more action variables may comprise at least one of water loop temperature and water loop flow rate. Further, the server 106 may be configured to generate at least one reward function based on the generated one or more action variables. In one example embodiment, the at least one reward function may correspond to at least one of real time energy cost for operating each of the plurality of WSHPs 110, thermal discomfort within an operating area of each of the plurality of WSHPs 110, stability or degradation information of heat in the WSHP system 104. In some embodiments, the server 106 may be configured to optimize at least one of the water loop temperature and the water loop flow rate of the WSHP system 104 based on the generated at least one reward function.

In some embodiments, the server 106 may further be configured to send the optimized generated at least one of the water loop temperature and the water loop flow rate of the WSHP system 104 to the user device 108. The user device 108 may be equipped by an operator, manager of the building or other service professionals responsible for monitoring and operating the WSHP system 104. In some embodiments, the optimized at least one of the water loop temperature and the water loop flow rate of the WSHP system 104 may provide a summarized data to the user to understand real time efficiency of the WSHP system 104 and may further be used to calculate overall monetary profit of the building after the improved efficiency of the WSHP system 104. In some embodiments, the user device 108 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

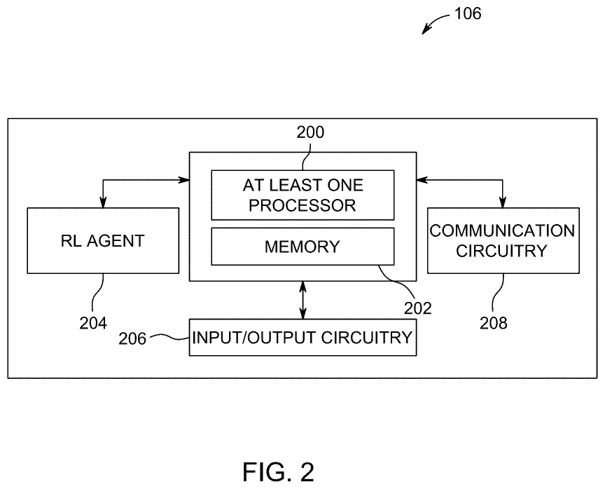

FIG. 2 illustrates a block diagram of the server 106 for selecting state, action, and reward variables by using a reinforcement learning (RL) agent 204 for the WSHP system 104 optimization, in accordance with an example embodiment of the present disclosure. The server 106 may comprise at least one processor 200, a memory 202, the RL agent 204, an input/output circuitry 206, and a communication circuitry 208.

In some embodiments, the server 106 may be communicatively coupled to the WSHP system 104 that may comprise the plurality of WSHPs 110 as illustrated in the FIG. 1. The at least one processor 200 may be configured to regulate various operations of the WSHP system 104. Further, the plurality of WSHPs 110 may be installed at level of individual zones or air handling units (AHU) inside the building. In some embodiments, each WSHP from the plurality of WSHPs 110 may either be in cooling, heating, or idle state based on a requirement of a zone or AHU during the operation of the WSHP system 104. In some embodiments, the server 106 by using the at least one processor 200 may be configured to deploy the trained RL agent 204 in the WSHP system 104. Further, the at least one processor 200 may be configured to analyze the one or more state variables associated with the WSHP system 104 in real-time, using the trained RL agent 204. In one example embodiment, the one or more state variables corresponds to a current state of the plurality of WSHPs 110, external heat sources (not shown) of the plurality of WSHPs 110, or water loop temperature (not shown) in the WSHP system 104.

In some embodiments, the at least one processor 200 may be configured to generate one or more action variables using the trained RL agent 204 based at least on the analyzed one or more state variables associated with the WSHP system 104. The one or more action variables may comprise at least one of water loop temperature and water loop flow rate. Further, the at least one processor 200 may be configured to generate at least one reward function based on the generated one or more action variables. In one example embodiment, the at least one reward function may correspond to at least one of real time energy cost for operating each of the plurality of WSHPs 110, thermal discomfort within an operating area of each of the plurality of WSHPs 110, stability or degradation information of heat in water loop of the WSHP system 104. Thereafter, the at least one processor 200 may be configured to optimize at least one of the water loop temperature and the water loop flow rate of the WSHP system 104 based on the generated at least one reward function.

In some embodiments, the at least one processor 200 may be communicatively coupled to the memory 202. The at least one processor 200 may include suitable logic, circuitry, and/or interfaces that are operable to execute one or more instructions stored in the memory 202 to perform predetermined operations. In one embodiment, the at least one processor 200 may be configured to decode and execute any instructions received from one or more other electronic devices or server(s). The at least one processor 200 may be configured to execute one or more computer-readable program instructions, such as program instructions to carry out any of the functions described in this description. Further, the processor may be implemented using one or more processor technologies known in the art. Examples of the at least one processor 200 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to deploy the trained RL agent 204 in the WSHP system 104. The memory 202 may be configured to include the instructions to analyze one or more state variables associated with the WSHP system 104 in real-time, using the trained RL agent 204. Further, the memory 202 may be configured to include the instructions to generate one or more action variables using the trained RL agent 204 based at least on the analyzed one or more state variables associated with the WSHP system. The memory 202 may be configured to include the instructions to generate at least one reward function based on the generated one or more action variables.

In some embodiments, the memory 202 may be configured to include the instructions to optimize at least one of the water loop temperature and the water loop flow rate of the WSHP system 104 based on the generated at least one reward function. It is apparent to a person with ordinary skill in the art that the one or more instructions stored in the memory 202 enable the hardware of the server 106 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuitry 206. The input/output circuitry 206 may enable a user to communicate or interface with the server 106, via one or more user devices (not shown). The one or more user devices may include N number of user devices. In some embodiments, the input/output circuitry 206 may act as a medium to transmit input from the interface to and from the server 106. In some embodiments, the input/output circuitry 206 may refer to the hardware and software components that facilitate the exchange of information between one or more user devices and the server 106. In one example, the server 106 may include a graphical user interface (GUI) (not shown) as input circuitry to allow the one or more users to input data. The input/output circuitry 206 may include various input devices such as keyboards, barcode scanners, GUI for the one or more users to provide data and various output devices such as displays, printers for the one or more users to receive data. In another example, the input/output circuitry 206 may include various output circuitry such as a display to show the real time energy cost.

In some embodiments, the server 106 may further comprise the communication circuitry 208. The communication circuitry 208 may allow the server 106 to exchange data or information with other systems or apparatuses. Further, the communication circuitry 208 may include network interfaces, protocols, and software modules responsible for sending and receiving data or information. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 208 may allow the server 106 to stay up-to-date and accurately track real time energy cost for operating the WSHP system 104. In some embodiments, the input/output circuitry 206 and the communication circuitry 208 may be configured to integrate the server 106 with other systems for centralized monitoring, analysis, and control by operators and automated processes. It will be apparent to one skilled in the art the above-mentioned components of the server 106 have been provided only for illustration purposes, without departing from the scope of the disclosure.

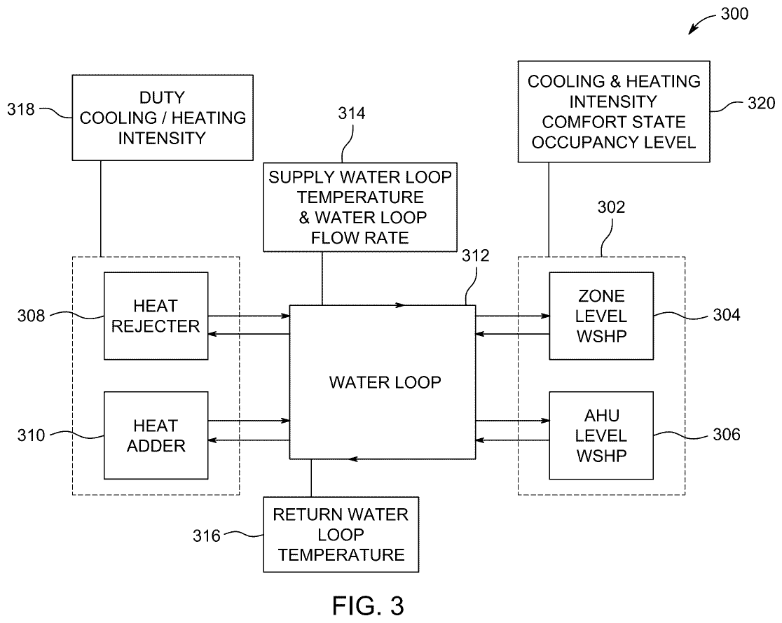

FIG. 3 illustrates an exemplary scenario 300 of the RL agent 204 that is configured to train based on the received one or more state variables associated with the WSHP system 104, in accordance with an example embodiment of the present disclosure. FIG. 3 is described in conjunction with FIG. 2.

As discussed herein, the at least one processor 200 may be configured to deploy the trained RL agent 204 in the WSHP system 104 comprising the plurality of WSHPs 110. Further, the at least processor 104 may be configured to receive the one or more state variables associated with the WSHP system 104, from one or more sensors (not shown), over a predefined period of time. Thereafter, the at least one processor 200 may be configured to train the RL agent 204 for the WSHP system 104 based at least on the received one or more state variables. In some embodiments, the one or more state variables may correspond to current state of the plurality of WSHPs 110, a current state of a building 302, all heat external heat sources and sinks 322. In one example embodiment, the plurality of WSHPs 110 may comprise at least one zone level WSHP 304 and an air handling unit (AHU) level WSHP 306. In one exemplary embodiment, the heat external heat sources and sinks 322 may comprise a heat rejecter 308 and a heat adder 310.

In some embodiments, the plurality of WSHPs 110 may be connected to the external heat sources and sinks 322 with a common water loop 312. In some embodiments, the at least one processor 200 may be configured to feed the received the one or more state variables to the RL agent 204 for training. In some embodiments, the at least one processor 200 may be configured to feed either necessary one or more state variables or either recommended one or more state variables to the RL agent 204. In some embodiments, the one or more state variables may comprise a supply water loop temperature and water loop flow rate 314, return water loop temperature 316, duty cooling/heating intensity 318 of the external heat sources and sinks 322, heating and cooling intensity, comfort state and occupancy level 320 in the building 302, speed of the plurality of WSHPs 110 and ambient conditions (not shown).

In some embodiments, the one or more state variables associated with the external heat sources and sinks 322 may further comprise electricity consumption of fan, speed of the fan and temperature associated to the heat rejecter 308. In some embodiments, the one or more state variables associated with the external heat sources and sinks 322 may further comprise stem/hot water consumption, heat exchanger tower temperature, gas consumption and supply/return temperature associated with the heat adder 310. In some embodiments, the cooling intensity, comfort state and occupancy level 320 may further comprise aggregated WSHP cooling intensity, aggregated WSHP heating intensity, aggregated WSHP electricity consumption, aggregated zone delta temperatures and aggregated occupancy level. Further, the ambient condition state variable comprises wet bulb temperature for the heat rejecter 308, dry bulb temperature, wind speed, sky cover and sun irradiation.

In some embodiments, the supply water loop temperature may be the temperature of the water that is circulated through the water loop 312 to facilitate the heat exchange process. In some embodiments, the supply water loop temperature may vary depending on whether the WSHP system 104 is operating in heating or cooling mode, as well as factors such as the design of the WSHP system 104, the temperature of the water source, and the heating or cooling demands of the building 302. Further, water loop flow rate may be the rate at which the water is circulated through the water loop 312. In some embodiments, water loop flow rate may be a critical parameter that affects the performance, efficiency, and overall operation of the WSHP system 104. In some embodiments, the at least one processor 200 may be configured to train the RL agent 204 based on the received one or more state variables.

In some embodiments, the at least one processor 200 may be configured to train the RL agent 204 using one or more Artificial Intelligence (AI)/Machine Learning (ML) techniques. For instance, the at least one processor 200 may employ supervised learning algorithms such as linear regression or decision trees to predict occupancy levels based on historical occupancy data collected from the plurality of sensors within each zone. Additionally, unsupervised learning techniques like clustering may be utilized to identify patterns and anomalies in occupancy behavior. Through iterative training and refinement processes, the at least one processor 200 may enhance the accuracy and effectiveness of the RL agent 204, to enhance the efficiency of the WSHP system 104.

In some exemplary embodiment, the at least one processor 200 may also be configured to determine occupancy of the building 302. In some embodiments, the at least one processor 200 may be configured to determine the occupancy by using a plurality of zone level occupancy sensors (not shown). In some embodiments, the plurality of zone level occupancy sensors may comprise at least one lightning sensors, Wi-Fi Access Points and Bluetooth low energy (BLE) sensors, access readers, and/or CO₂ sensor. Further, the at least one processor 200 may also be configured to determine the occupancy by using lightening sensors. In an exemplary embodiment, when the at least one lightning sensors may be configured to determine the occupancy data of the one or more zones.

Further, the at least one lightening sensors may be configured to detect disturbances or changes in the electromagnetic field of the building 302, caused by any human presence. The at least one lightning sensors may utilize passive infrared (IR) signals which detects infrared radiations emitted by the human body. In another exemplary embodiment, when the Wi-Fi Access Points and Bluetooth low energy (BLE) sensors may be configured to determine the occupancy data of the one or more zones. Further, the Wi-Fi Access Points and Bluetooth low energy (BLE) sensors may be configured to detect presence of the devices equipped with Wi-Fi or BLE capabilities. The Wi-Fi access points may be configured to monitor the signals from nearby devices connected to the network. Further, the BLE sensors may be configured to determines presence of the BLE-enabled devices in proximity. In some embodiments, when the devices equipped with the Wi-Fi or BLE capabilities connects/disconnects, the occupancy data may be detected by the Wi-Fi Access Points and Bluetooth low energy (BLE) sensors.

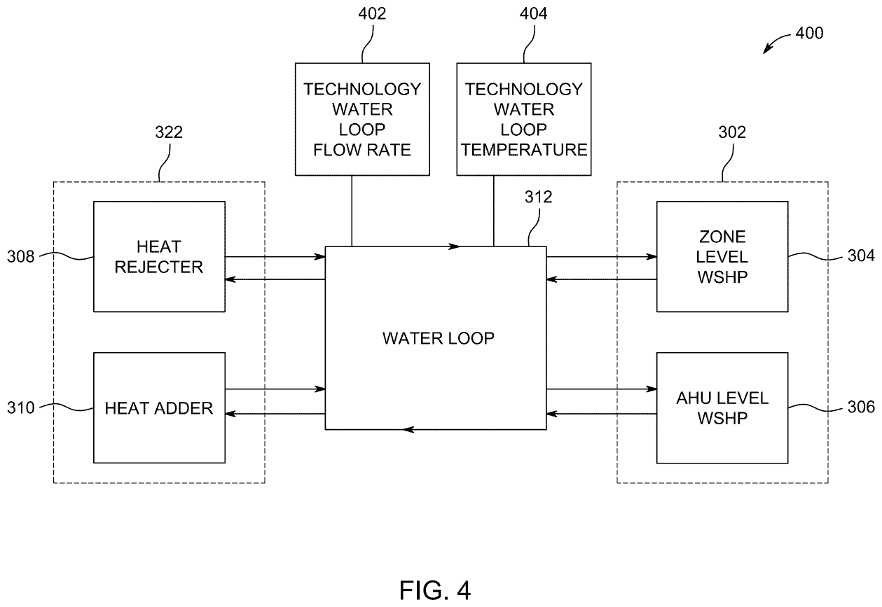

FIG. 4 illustrates an exemplary scenario 400 of the at least one processor 200 that is configured to generate one or more action variables using the trained RL agent 204. FIG. 4 is described in conjunction with FIGS. 2 and 3.

In some embodiments, the at least one processors 200 may be configured to analyze by using the trained RL agent 204 the one or more state variables associated with the WSHP system 104 in real-time. Further, the at least one processor 200 may be configured to generate one or more action variables using the trained RL agent 204 based at least on the analyzed one or more state variables associated with each of the plurality of WSHPs 110. In some embodiments, the trained RL agent 204 may be configured to optimize and address a technology water loop flow rate 402 and a technology water loop temperature 404 within the water loop 312 of the WSHP system 104.

In some embodiments, the at least one processor 200 by using the trained RL agent 204, may be configured to determine a technology water loop temperature set point. In some embodiments, the technology water loop temperature set point may be a specific or a range of temperature at which the heat rejecter 308 may be configured to set the temperature of the water flowing inside the water loop 312 towards the building 302 for the plurality of WSHPs 110. In some example embodiment, the at least one RL agent 204 may be configured to set a HI-LOW temperature set points as a technology water cooling temperature set point and a technology water heating temperature set point. In some example embodiments, for heating mode, the trained RL agent 204 may be configured to set the technology water loop temperature between a range from around 80° F. (27° C.) to 120° F. (49° C.) or higher. In some other example embodiment, for cooling model, the trained RL agent 204 may be configured to set the water loop temperature may range from approximately 45° F. (7° C.) to 70° F. (21° C.) or lower.

Further, the at least one processor 200 by using the trained RL agent 204 may generate the technology water loop temperature set point. The technology water loop temperature set point may comprise technology water loop flow rate, technology water pump speed, and technology water circuit delta pressure set point. In some embodiments, the trained RL agent 204 may be configured to set the technology water loop temperature set point such that the water flowing in the water loop 312 has a chance to extract heat from the water source efficiently to meet the building's heating demand. In some example embodiment, the trained RL agent 204 may set the technology water loop flow rate at 2-4 gallons per minute within the water loop 312.

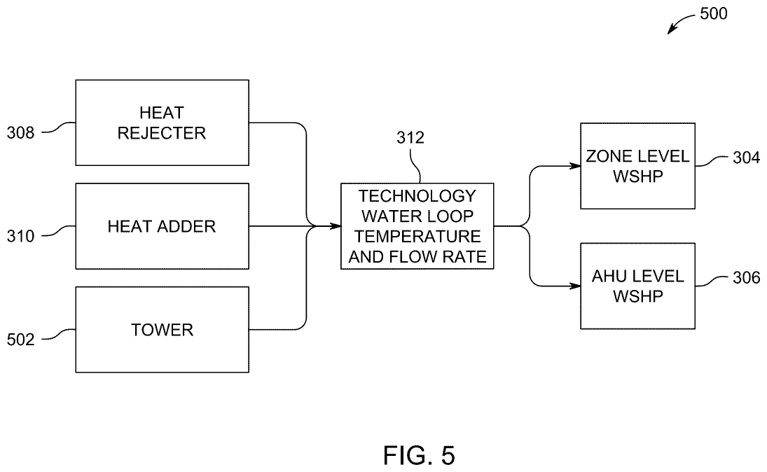

FIG. 5 illustrates an exemplary scenario 500 of the at least one processor 200 that is configured to generate at least one reward function using the trained RL agent 204, in accordance with an example embodiment of the present disclosure. FIG. 5 is described in conjunction with FIGS. 2-4.

In some embodiments, the at least one processor 200 may be configured to generate at least one reward function based on the generated one or more action variables as described in FIG. 4. Further, the at least one reward function may comprise an energy component and zero or more penalties. The zero or more penalties may depend upon the thermal discomfort within the operating area of the WSHP system 104, and the stability or degradation information of heat in the water loop of the WSHP system 104. In some embodiments, the at least one processor 200 may be configured to determine real time energy cost for operating the WSHP system 104 using a utility tariff module (not shown). The real time energy cost for operating the WSHP system 104 may correspond to energy costs of external heat sources 210 i.e. heat rejecter 308, heat adder 310 and a tower 502 and energy cost for the operating area of the WSHP system 104. In some embodiments, the utility tariff module may be configured to check how an energy provider charges one or more users for the energy usage in the system. The utility tariff module may be configured to compute real-time energy costs, and calculate costs based on prevailing utility rates and consumption patterns to facilitate effective optimization of the WSHP system 104.

As discussed herein, the at least one processor 200 may be configured to determine the real time energy cost for operating the WSHP system 104 using the utility tariff module. The real time energy cost for operating the WSHP system 104 may correspond to energy costs of the external heat sources 210 and energy cost for the operating area of the WSHP system 104. In some embodiments, the utility tariff module may be configured to check how an energy provider charges one or more users for the energy usage in the system 100. The utility tariff module may be configured to compute real-time energy costs, and calculate costs based on prevailing utility rates and consumption patterns to facilitate effective optimization of the WSHP system 104.

In some embodiments, the water loop 312 may be optimized to minimize real time energy cost while satisfying the comfort state. The at least one reward may address the real time energy cost. In some embodiments, the real time energy cost may be computed using energy meters both on supply side and the demand side. In some embodiments, the supply side may include a heat rejecter 212, a heat adder 214, and the tower 502 for cooling and heating mode. Further, the demand side may include the zone level WSHP 304 and AHU level WSHP 306. The energy meters may compute the cost of electricity, both from the demand side and the supply side.

In one example embodiment, if a plurality of utilities, such as electricity and gas, is used or in another example embodiment, the utility price is variable during day, then the real time energy cost may be computed by applying utility tariff. Further, the at least one reward function may comprise zero or more penalties. The zero or more penalties may depend upon the thermal discomfort within the operating area of the WSHP system 104, and the stability or degradation information of heat in the water loop of the WSHP system 104. In some embodiments, there may be no need to consider comfort as the plurality of WSHPs 110 may satisfy comfort for wide range of water loop 312 temperatures. In one case, if the comfort may not be applied for specific facility, then zero or more penalties may be added to the at least one reward.

It will be apparent that the components of the system 100 disclosed herein are provided only for illustrative purposes. Any modification to the current design and overall operation may be well appreciated, without departing from the scope of the disclosure.

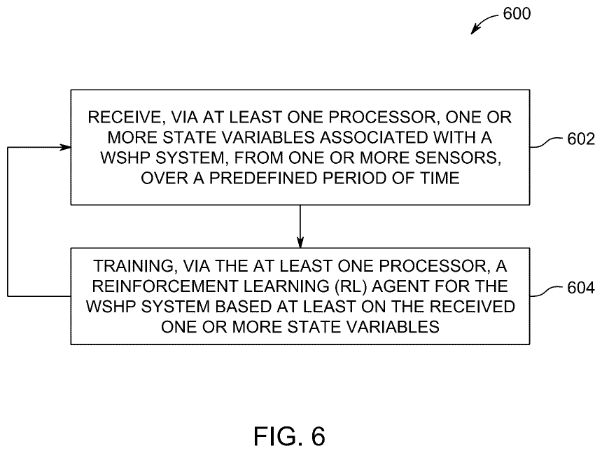

FIG. 6 illustrates a flowchart showing a method 600 for training the RL agent 204 by the at least one processor 200, in accordance with an example embodiment of the present disclosure.

At operation 602, the at least one processor 200 may be configured to receive the one or more state variables associated with the WSHP system 104, from one or more sensors, over a predefined period of time. In some embodiments, the at least one processor 200 may be configured to train the RL agent 204 for the WSHP system 104 based at least on the received one or more state variables. In some embodiments, the one or more state variables may correspond to current state of the plurality of WSHPs 110, current state of a building 302, all heat external heat sources and sinks 322. In one example embodiment, the plurality of WSHPs 110 may comprise at least one zone level WSHP 304 and air handling unit (AHU) level WSHP 306. In one exemplary embodiment, the heat external heat sources and sinks 322 may comprise a heat rejecter 308 and a heat adder 310.

At operation 604, the at least one processor 200 may be configured to train the RL agent 204 for the WSHP system based at least on the received one or more state variables. In some embodiments, the at least one processors 200 may be configured to feed either necessary one or more state variables or either recommended one or more state variables to the RL agent 204. In some embodiments, the one or more state variables may comprise a supply water loop temperature and water loop flow rate 314, return water loop temperature 316, duty cooling/heating intensity 318 of the external heat sources and sinks 322, heating and cooling intensity, comfort state and occupancy level 320 in the building 302, speed of the plurality of WSHPs 110 and ambient conditions (not shown).

In some embodiments, the one or more state variables associated with the external heat sources and sinks 322 may further comprise electricity consumption of fan, speed of the fan and temperature associated to the heat rejecter 308. In some embodiments, the one or more state variables associated with the external heat sources and sinks 322 may further comprise stem/hot water consumption, heat exchanger tower temperature, gas consumption and supply/return temperature associated with the heat adder 310. In some embodiments, the cooling intensity, comfort state and occupancy level 320 may further comprise aggregated WSHP cooling intensity, aggregated WSHP heating intensity, aggregated WSHP electricity consumption, aggregated zone delta temperatures, and aggregated occupancy level. Further, the ambient condition state variable comprises wet bulb temperature for the heat rejecter 308, dry bulb temperature, wind speed, sky cover and sun irradiation.

In some embodiments, the supply water loop temperature may be the temperature of the water that is circulated through the water loop 312 to facilitate the heat exchange process. In some embodiments, the supply water loop temperature may vary depending on whether the WSHP system 104 is operating in heating or cooling mode, as well as factors such as the design of the WSHP system 104, the temperature of the water source, and the heating or cooling demands of the building 302. Further, water loop flow rate may be the rate at which the water is circulated through the water loop 312. In some embodiments, water loop flow rate may be a critical parameter that affects the performance, efficiency, and overall operation of the WSHP system 104. In some embodiments, the at least one processor 200 may be configured to train the RL agent 204 based on the received one or more state variables.

In some embodiments, the at least one processor 200 may be configured to train the RL agent 204 using one or more Artificial Intelligence (AI)/Machine Learning (ML) techniques. For instance, the at least one processor 200 may employ supervised learning algorithms such as linear regression or decision trees to predict occupancy levels based on historical occupancy data collected from the plurality of sensors within each zone. Additionally, unsupervised learning techniques like clustering may be utilized to identify patterns and anomalies in occupancy behavior. Through iterative training and refinement processes, the at least one processor 200 may enhance the accuracy and effectiveness of the RL agent 204, to enhance the efficiency of the WSHP system 104. In some embodiments, the at least one processor 200 may redirect at operation 602 to train the at least one trained RL agent 204 with new set of one or more state variables of the WSHP system 104.

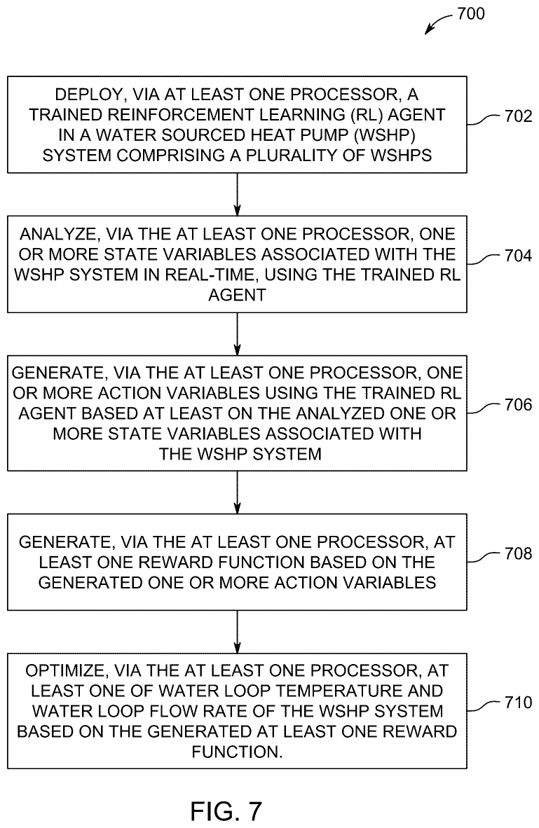

FIG. 7 illustrates a flowchart showing a method 700 for optimizing the WSHP system 104 using the RL agent 204, in accordance with an example embodiment of the present disclosure. FIG. 7 is described in conjunction with FIGS. 1-6.

At operation 702, the at least one processor 200 may be configured to deploy the trained RL agent 204 in the WSHP system 104 comprising the plurality of WSHPs 110. The trained RL agent 204 may be generated by the at least one processor 200 by receiving the one or more state variables associated with the WSHP system 104, from one or more sensors, over a predefined period of time. Thereafter, the at least one processor 200 may be configured to train the RL agent 204 for the WSHP system 104 based at least on the received one or more state variables.

For example, the at least one processor 200 is employed to deploy trained RL agent 204 within the WSHP system 104, equipped with data gathered from various sensors installed within the WSHP system 104 of the office building for 7 days i.e. starting from 20^{th} January to 26^{th} January 2024. The data includes parameters such as temperature, pressure, occupancy levels, and external heat source utilization. Subsequently, using the collected data between 20^{th} January to 26^{th} January 2024, the at least one processor 200 trains the RL agent 204 of the WSHP system 104 to learn and adapt based on collected data.

At operation 704, the at least one processor 200 may be configured to analyze one or more state variables associated with the WSHP system 104 in real-time, using the trained RL agent 204. In some embodiments, the one or more state variables may correspond to a current state of each of the plurality of WSHPs 110, external heat sources and sinks 322 of each of the plurality of WSHPs 110, or water loop temperature in the WSHP system 104. In some embodiments, the current state of the plurality of WSHPs 110 may comprise at least one of cooling intensity and heating intensity in the building 302, occupancy level, and comfort state. In some embodiments, the external heat sources and sinks 322 may have one or more parameters such as electricity consumption of a cooling tower, fan speed, tower delta temperature, steam or hot water consumption, heat exchanger delta temperature, gas consumption, supply or return delta temperature, aggregated WSHP cooling intensity, aggregated WSHP heating intensity, aggregated WSHP electricity consumption, aggregated zone delta temperature, or aggregated occupancy level.

For example, in real-time operation, the at least one processor 200 may conduct analysis of the one or more state variables using the trained RL agent 204. The one or more state variables encompass current operational states, external heat sources and sinks 322 utilization, and water loop temperatures. The at least one processor 200 interprets the one or more state variables to optimize energy costs, considering factors such as cooling and heating tower operations and operational costs within the WSHP system 104 area. Additionally, the at least one processor 200 defines temperature set points, such as 40° Celsius to 60° Celsius for heating based on these variables, to enable the trained RL agent 204 to adjust the water loop temperature accordingly. Moreover, parameters like water flow rate and pump speed are optimized to enhance overall performance of the WSHP system 104.

At operation 706, the at least one processor 200 may be configured to generate one or more action variables using the trained RL agent 204 based at least on the analyzed one or more state variables associated with the WSHP system 104. In some embodiments, the one or more action variables may comprise at least one of water loop temperature and water loop flow rate. The water loop flow rate may comprise at least one of a water flow rate, water pump speed, or water circuit delta pressure set point. For example, the at least one processor 200 generates one or more action variables based on the analyzed one or more state variables, typically involving adjustments to water loop temperature and flow rate.

At operation 708, the at least one processor 200 may be configured to generate at least one reward function based on the generated one or more action variables. In some embodiments, the at least one reward function may correspond to at least one of real time energy cost for operating each of the plurality of WSHPs 110, thermal discomfort within an operating area of each of the plurality of WSHPs 110, stability or degradation information of heat in water loop of the WSHP system 104. In some embodiments, the real time energy cost for operating the WSHP system 104 may correspond to energy costs of the external heat sources and sinks 322 and energy cost for the operating area of the WSHP system 104. Further, the at least one reward function may comprise an energy component and zero or more penalties. The zero or more penalties may depend upon the thermal discomfort within the operating area of the WSHP system 104 and the stability or degradation information of heat in the water loop 312 of the WSHP system 104. For example, the at least one processor 200 formulates at least one reward function considering factors such as real-time energy costs, thermal comfort, and heat stability within the water loop 312.

At operation 710, the at least one processor 200 may be configured to optimize, at least one of the water loop temperature and the water loop flow rate of the WSHP system 104 based on the generated at least one reward function. In some embodiments, the optimization of the water loop temperature may be performed by defining a water cooling temperature set point and a water heating temperature set point. For example, based at least on the generated reward functions, the at least one processor 200 optimizes the water loop temperature and the water loop flow rate of the WSHP system 104 to ensure efficient operation of the WSHP system 104.

In some embodiments, the method may further comprise determining, via the at least one processor 200, the real time energy cost for operating the WSHP system 104 using the utility tariff module. In some embodiments, the utility tariff module may be configured to check how an energy provider charges one or more users for the energy usage in the WSHP system 104. The utility tariff module may be configured to compute real-time energy costs, and calculate costs based on prevailing utility rates and consumption patterns to facilitate effective optimization of the WSHP system 104.

In some embodiments, a non-transitory machine-readable information storage medium (not shown) may be provided, comprising one or more instructions which when executed by at least one processor 200 cause implementing the trained reinforcement learning (RL) agent 204 for dynamically controlling at least one of water loop temperature and water loop flow rate of a water sourced heat pump (WSHP) system 104 by deploying, via the at least one processor 200, the trained RL agent 204 in the WSHP system 104 comprising the plurality of WSHPs 110. Further, the trained RL agent 204 may dynamically control the water loop temperature and water loop flow rate of the WSHP system 104 by analyzing, via the at least one processor 200, one or more state variables associated with the WSHP system 104 in real-time, using the trained RL agent 204. The one or more state variables may correspond to a current state of each of the plurality of WSHPs 110, external heat sources and sinks 322 of each of the plurality of WSHPs 110, or water loop temperature in the WSHP system 104. Further, the trained RL agent 204 may dynamically control the water loop temperature and water loop flow rate of the WSHP system 104 by generating, via the at least one processor 200, one or more action variables using the trained RL agent 204 based at least on the analyzed one or more state variables associated with the WSHP system 104. The one or more action variables may comprise at least one of water loop temperature and water loop flow rate.

Further, the trained RL agent 204 may dynamically control the water loop temperature and water loop flow rate of the WSHP system 104 by generating, via the at least one processor 200, at least one reward function based on the generated one or more action variables. The at least one reward function may correspond to at least one of a real time energy cost for operating each of the plurality of WSHPs 110, thermal discomfort within an operating area of each of the plurality of WSHPs 110, stability or degradation information of heat in water loop 312 of the WSHP system 104. Thereafter, the trained RL agent 204 may dynamically control the WSHP by optimizing, via the at least one processor 200, at least one of the water loop temperature and the water loop flow rate of the WSHP system 104 based on the generated at least one reward function.

In some embodiments, the trained RL agent 204 may be generated by receiving, via the at least one processor 200, the one or more state variables associated with the WSHP system 104, from one or more sensors, over a predefined period of time. Further, training, via the at least one processor 200, the RL agent 204 for the WSHP system 104 based at least on the received one or more state variables.

In some embodiments, the optimization of the water loop temperature is performed by defining a water cooling temperature set point and a water heating temperature set point. Further, the water loop flow rate comprises at least one of a water flow rate, water pump speed, or water circuit delta pressure set point.

The present disclosure provides no or low setup cost of the system and provides a significant energy saving costs to users. In some embodiments, the present disclosure reduces heating and cooling costs in building equipped with Water Sourced Heat Pumps (WSHP) while keeping comfort at the same level. Further, the present disclosure minimizes purchased building-level utility costs, that typically includes electricity costs, by optimizing technology water loop temperature and flowrate. Consequently, the method and the system successfully optimizes the water loop temperature in an effort to minimize overall system energy consumption.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
deploying, via at least one processor, a trained reinforcement learning (RL) agent in a water sourced heat pump (WSHP) system comprising a plurality of WSHPs;
analyzing, via the at least one processor, one or more state variables associated with the WSHP system in real-time, using the trained RL agent, wherein the one or more state variables corresponds to a current state of each of the plurality of WSHPs, external heat sources of each of the plurality of WSHPs, or water loop temperature in the WSHP system;
generating, via the at least one processor, one or more action variables using the trained RL agent based at least on the analyzed one or more state variables associated with the WSHP system, wherein the one or more action variables comprises at least one of water loop temperature and water loop flow rate;
generating, via the at least one processor, at least one reward function based on the generated one or more action variables, wherein the at least one reward function corresponds to at least one of real time energy cost for operating the WSHP system, thermal discomfort within an operating area of the WSHP system, stability or degradation information of heat in water loop of the WSHP system; and
optimizing, via the at least one processor, at least one of the water loop temperature and the water loop flow rate of the WSHP system based on the generated at least one reward function.

2. The method of claim 1, wherein the trained RL agent is generated by:
receiving, via the at least one processor, the one or more state variables associated with the WSHP system, from one or more sensors, over a predefined period of time; and
training, via the at least one processor, the RL agent for the WSHP system based at least on the received one or more state variables.

3. The method of claim 1, wherein the optimization of the water loop temperature is performed by defining a water cooling temperature set point and a water heating temperature set point.

4. The method of claim 1, wherein the water loop flow rate comprises at least one of a water flow rate, water pump speed, or water circuit delta pressure set point.

5. The method of claim 1 further comprising:
determining, via the at least one processor, the real time energy cost for operating the WSHP system using a utility tariff module.

6. The method of claim 1, wherein the current state of the plurality of WSHPs comprises at least one of cooling intensity and heating intensity in a facility, occupancy level, and comfort state.

7. The method of claim 1, wherein the external heat sources having one or more parameters such as electricity consumption of a cooling tower, fan speed, tower delta temperature, steam or hot water consumption, heat exchanger delta temperature, gas consumption, supply or return delta temperature, aggregated WSHP cooling intensity, aggregated WSHP heating intensity, aggregated WSHP electricity consumption, aggregated zone delta temperature, or aggregated occupancy level.

8. The method of claim 1, wherein the real time energy cost for operating the WSHP system corresponds to energy costs of the external heat sources and energy cost for the operating area of the WSHP system.

9. The method of claim 1, wherein the at least one reward function comprises an energy component and zero or more penalties, wherein the zero or more penalties depends upon the thermal discomfort within the operating area of the WSHP system and the stability or degradation information of heat in the water loop of the WSHP system.

10. A system comprising:
a memory; and
at least one processor communicatively coupled to the memory, wherein the at least one processor is configured to:
deploy a trained reinforcement learning (RL) agent in a water sourced heat pump (WSHP) system comprising a plurality of WSHPs;
analyze one or more state variables associated with the WSHP system in real-time, using the trained RL agent, wherein the one or more state variables corresponds to a current state of the plurality of WSHPs, external heat sources of the plurality of WSHPs, or water loop temperature in the WSHP system;
generate one or more action variables using the trained RL agent based at least on the analyzed one or more state variables associated with the WSHP system, wherein the one or more action variables comprises at least one of water loop temperature and water loop flow rate;
generate at least one reward function based on the generated one or more action variables, wherein the at least one reward function corresponds to at least one of real time energy cost for operating the WSHP system, thermal discomfort within an operating area of the WSHP system, stability or degradation information of heat in water loop of the WSHP system; and
optimize at least one of the water loop temperature and the water loop flow rate of the WSHP system based on the generated at least one reward function.

11. The system of claim 10, wherein the at least one processor is further configured to:
receive the one or more state variables associated with the WSHP system, from one or more sensors, over a predefined period of time; and
train the RL agent for the WSHP system based at least on the received one or more state variables.

12. The system of claim 10, wherein the optimization of the water loop temperature is performed by defining a water cooling temperature set point and a water heating temperature set point.

13. The system of claim 10, wherein the water loop flow rate comprises at least water flow rate, water pump speed, or water circuit delta pressure set point.

14. The system of claim 10, wherein the at least one processor is further configured to:
determine the real time energy cost for operating the WSHP system using a utility tariff module.

15. The system of claim 10, wherein the current state of the plurality of WSHPs comprises at least one of cooling intensity and heating intensity in a facility, occupancy level, and comfort state.

16. The system of claim 10, wherein the external heat sources having one or more parameters such as electricity consumption of a cooling tower, fan speed, tower delta temperature, steam or hot water consumption, heat exchanger delta temperature, gas consumption, supply or return delta temperature, aggregated WSHP cooling intensity, aggregated WSHP heating intensity, aggregated WSHP electricity consumption, aggregated zone delta temperature, or aggregated occupancy level.

17. The system of claim 10, wherein the at least one reward function comprises an energy component and zero or more penalties, wherein the zero or more penalties depends upon the thermal discomfort within the operating area of the WSHP system, and the stability or degradation information of heat in the water loop of the WSHP system.

18. A non-transitory machine-readable information storage medium comprising one or more instructions which when executed by at least one processor cause implementing a trained reinforcement learning (RL) agent for dynamically controlling at least one of water loop temperature and water loop flow rate of a water sourced heat pump (WSHP) system by:
deploying the trained RL agent in the WSHP system comprising a plurality of WSHPs;
analyzing one or more state variables associated with the WSHP system in real-time, using the trained RL agent, wherein the one or more state variables corresponds to a current state of each of the plurality of WSHPs, external heat sources of each of the plurality of WSHPs, or water loop temperature in the WSHP system;
generating one or more action variables using the trained RL agent based at least on the analyzed one or more state variables associated with the WSHP system, wherein the one or more action variables comprises at least one of the water loop temperature and water loop flow rate;
generating at least one reward function based on the generated one or more action variables, wherein the at least one reward function corresponds to at least one of real time energy cost for operating the WSHP system, thermal discomfort within an operating area of each of the WSHP system, stability or degradation information of heat in water loop of the WSHP system; and
optimizing at least one of the water loop temperature and the water loop flow rate of the WSHP system based on the generated at least one reward function.

19. The non-transitory machine-readable information storage medium of claim 18, wherein the at least one processor is configured to:
receive the one or more state variables associated with the WSHP system, from one or more sensors, over a predefined period of time; and
train the RL agent for the WSHP system based at least on the received one or more state variables.

20. The non-transitory machine-readable information storage medium of claim 18, wherein the optimization of the water loop temperature is performed by defining a water cooling temperature set point and a water heating temperature set point, and wherein the water loop flow rate comprises at least one of a water flow rate, water pump speed, or water circuit delta pressure set point.
